(19) United States
(12) Patent Application Publication
(10) Pub. No.: US 2017/0284474 A1
(43) Pub. Date: Oct. 5, 2017

(54) COUPLER FOR A POWER TAKE-OUT AXLE OF A GEARBOX

(71) Applicant: APEX DYNAMICS, INC., Taichung city (TW)

(72) Inventor: Robin C.S. CHANG, Taichung City (TW)

(21) Appl. No.: 15/088,116

(22) Filed: Apr. 1, 2016

(51) Int. Cl. F16D 1/076; F16H 55/17

(52) U.S. Cl. CPC F16D 1/076; F16H 55/17

(57) ABSTRACT

A coupler is provided for a power-take-out axle of a gearbox. The coupler includes a coupling flange, a pinion, and a threaded bolt. The coupling flange includes a screw hole and the first curvic coupling member that are arranged in a concentric manner. The pinion is connected to a front end of the coupling flange, and includes a countersink hole, teeth and a second curvic coupling member arranged in concentric manner. The threaded bolt is inserted in the screw hole from the front end of the pinion through the countersink hole. Hence, the pinion and the coupling flange are bonded.

### BACKGROUND OF INVENTION

### 1. Field of Invention

The present invention relates to transfer of power through a gearbox and, more particularly, to a coupler for connecting a power-take-out (“PTO”) axle of a gearbox to another mechanical element.

### 2. Related Prior Art

A PTO axle of a conventional gearbox is connected to a coupler. For example, DE102007028873 discloses a coupling flange 3, a pinion 5, a clamping element 27, and a socket 31. The coupling flange 3 includes a reduced neck 29 and a bore 23 axially made throughout the coupling flange 3 and the reduced neck 29. The pinion 5 is axially formed with an axle 25 inserted in the bore 23 of the coupling flange 3 to serially connect the coupling flange 3 to the pinion 5. The socket 31 and the clamping element 27 are engaged with the reduced neck 29 and hence fitted on the coupling flange 3 and the pinion 5. The coupling flange 3 is further connected to a PTO axle 7 of a gearbox. Thus, power is transferred to the pinion 5 from the PTO axle 7, and further transferred to another mechanical element from the pinion 5.

The clamping element 27 and the socket 31 are fitted on the coupling flange 3 and the pinion 5 for synchronous rotation. However, this mechanism is not used without any problem. Firstly, it includes a lot of elements. The cost of materials and the cost of fabrication are high. In addition, the concentricity of the elements requires high precision, and an accumulated error is large. Secondly, the axle 25 of the pinion 5 is engaged with the coupling flange 3 by fitting the clamping element 27 and the socket 31. The engagement might be jeopardized when the mechanism is used to transfer an excessive value of torque. Moreover, the clamping element 27 is provided between the pinion 5 and the coupling flange 3, and the fitting thereof in assembly could easily be interfered with in a limited space.

DE102008024707, FIG. 3, a coupler includes a coupling flange 3 and a pinion 5. The coupling flange 3 includes an axial bore 23. The pinion 5 includes an axial axle 25 that is inserted in the axial bore 23 of the coupling flange 3 to serially connect the coupling flange 3 to the pinion 5. The coupling flange 3 is secured to the pinion 5 by welding.

Thus, the coupler disclosed in DE102008024707 solves the problems with the coupler disclosed in DE102007028873. However, the use of the coupler disclosed in DE102008024707 is not without any problem. it takes a lot of effort to keep an external face of the axle 25 of the pinion 5 in proper contact with the internal faces of the coupling flange 3 and the bore 23 during the welding to achieve excellent welding although the welding renders possible a small number of elements and hence a low cost of the purchase of the elements and a low cost of putting the elements together. Otherwise, the welding could be inadequate. In addition, the materials of the elements must be taken into consideration to connect them to one another by welding. The bonding of the grains of the materials could easily be broken to render points 49 of welding fragile and hence jeopardize the ability to transfer torque. Moreover, the points 49 of welding are only located on the surfaces of the elements, and could easily be broken when the mechanism is subjected to a tremendous value of shearing when the mechanism is used to transfer a large value of torque. In addition, both of the coupling flange 3 and the pinion 5 must be replaced with new ones when only one of them is broken because they are secured to each other by welding. This is a waste of materials and money, and causes a lot of troubles in maintenance and purchase.

DE102013000428 discloses another coupling mechanism including a coupling flange 2 and a pinion 3. An end of the coupling flange 2 is formed with teeth engaged with teeth formed on an end of the pinion 3 to connect the coupling flange 2 to the pinion 3. Referring to FIG. 2 of DE102013000428, the end of the coupling flange 2 and the end of the pinion 3 are inclined faces. With such a design, undesired components of forces occur. In addition, the concentricity of the elements must be corrected and an accumulated error could easily occur for lacking any element to align the coupling flange 2 to the pinion 3 when the teeth of the former are engaged with those of the latter. Moreover, referring to FIG. 1 of DE102013000428, each of the teeth includes a sharp tip that is weak. Furthermore, to replace the pinion 3 with a new one, the coupling flange 2 must be taken from the PTO axle of the gearbox before the threaded bolt 15 can be loosened to release the pinion 3, which is previously attached to the end of the coupling flange 2 by the threaded bolt 15, because the pinion insertion of a threaded bolt 15 starts from an end of the coupling flange 2 that is pressed against the PTO axle of the gearbox. Such a process is complicated, and takes a lot of time. The correction of the concentricity of the elements causes a lot of troubles and takes a lot of time after the replacement.

The present invention is therefore intended to obviate or at least alleviate the problems encountered in prior art.

### SUMMARY OF INVENTION

It is the primary objective of the present invention to provide an inexpensive, strong and convenient coupler for a power take-out axle of a gearbox.

To achieve the foregoing objectives, the coupler includes a coupling flange, a pinion, and a threaded bolt. The coupling flange includes a screw hole and the first curvic coupling member that are arranged in a concentric manner. The pinion is connected to a front end of the coupling flange, and includes a countersink hole, teeth and a second curvic coupling member arranged in concentric manner. The threaded bolt is inserted in the screw hole from the front end of the pinion through the countersink hole. Hence, the pinion and the coupling flange are bonded.

An advantage of the coupler is that the coupling flange and the pinion are synchronously movable and power can be transferred between them for the engagement of the first curvic coupling member with the second curvic coupling member.

Another advantage of the coupler is perfect concentricity and excellent strength due to the engagement of the first curvic coupling member with the second curvic coupling member.

Another advantage of the coupler is convenient rotation of the threaded bolt member.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a perspective view of a coupler according to the first embodiment of the present invention;

FIG. 2 is an exploded view of the coupler shown in FIG. 1;

FIG. 3 is a cross-sectional view of the coupler shown in FIG. 1; and

FIG. 4 is a perspective view of a coupler according to the second embodiment of the present invention.

### DETAILED DESCRIPTION OF EMBODIMENTS

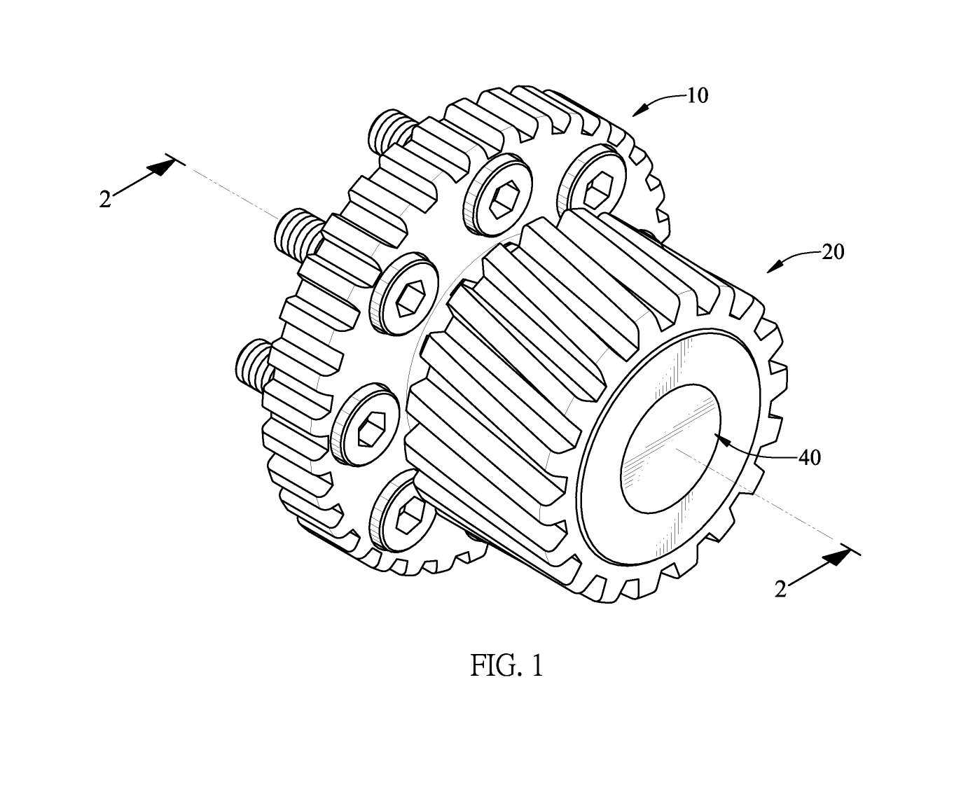

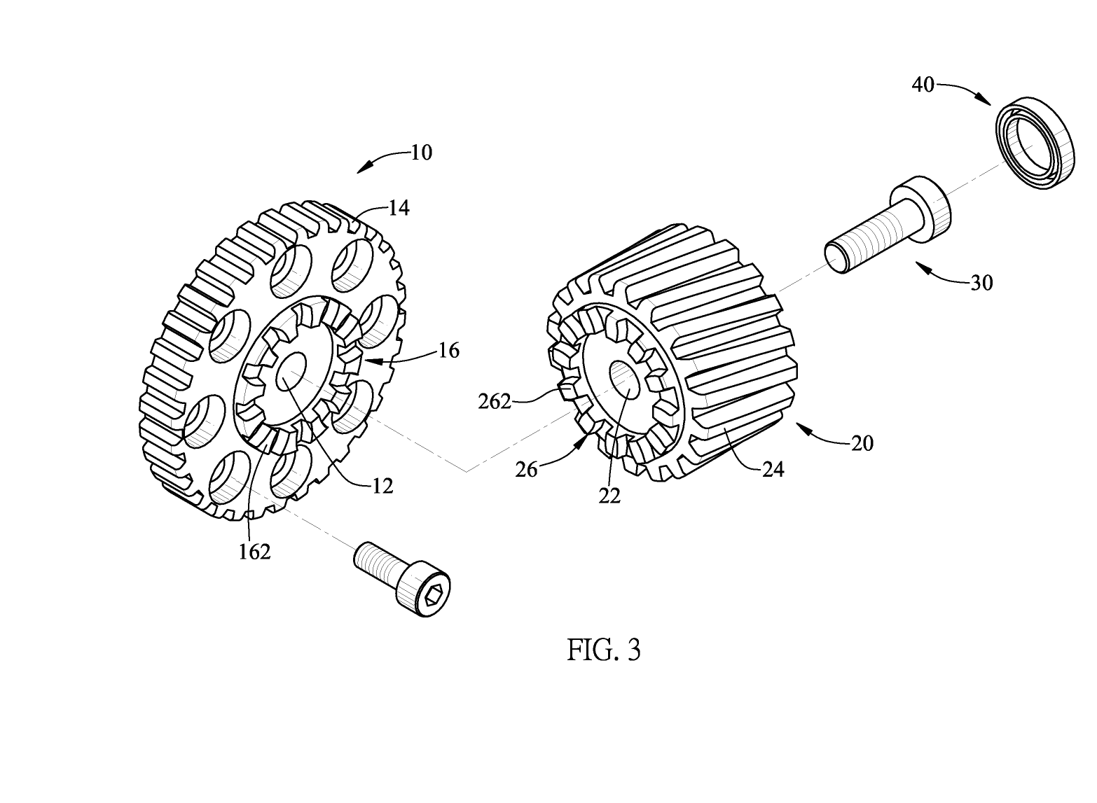

Referring to FIGS. 1 to 3, a coupler includes a coupling flange 10, a pinion 20, a threaded bolt 30 and a cover 40 arranged in a coaxial manner according to a first embodiment of the present invention.

The coupling flange 10 includes a screw hole 12, teeth 14, and a first curvic coupling member 16 in a concentric manner. The screw hole 12 is made in a front end of the coupling flange 10. The teeth 14 are formed on the periphery of the coupling flange 10. The first curvic coupling member 16 is formed at the front end of the coupling flange 10, and includes first-type curvic teeth 162 separated from one another by gaps (not numbered). The first-type curvic teeth 162 can be straight concave teeth, straight convex teeth, concave-concave teeth, concave-convex teeth, convex-convex teeth or convex-concave teeth.

The pinion 20 includes a countersink hole 22, teeth 24, and a second curvic coupling member 26. The countersink hole 22 is axially made throughout the pinion 20, and sequentially includes a large portion and a small portion. The teeth 24 are formed on the periphery of the pinion 20. The second curvic coupling member 26 are formed at a rear end of the pinion 20, corresponding to the first curvic coupling member 16, which is formed at the front end of the coupling flange 10. The second curvic coupling member 26 includes second-type curvic teeth 262 separated from one another by gaps. The second-type curvic teeth 262 can be straight concave teeth, straight convex teeth, concave-concave teeth, concave-convex teeth, convex-convex teeth or convex-concave teeth.

The threaded bolt 30 is inserted in the screw hole 12 of the coupling flange 10 from the front end of the pinion 20 via the countersink hole 22. Thus, the pinion 20 and the coupling flange 10 are bonded.

The cover 40 is fitted in the countersink hole 22 of the pinion 20 to close the countersink hole 22 to shield and protect the threaded bolt 30. The cover 40 is flush with the front end of the pinion 20. The profile of the cover 40 is made in compliance with that of the countersink hole 22.

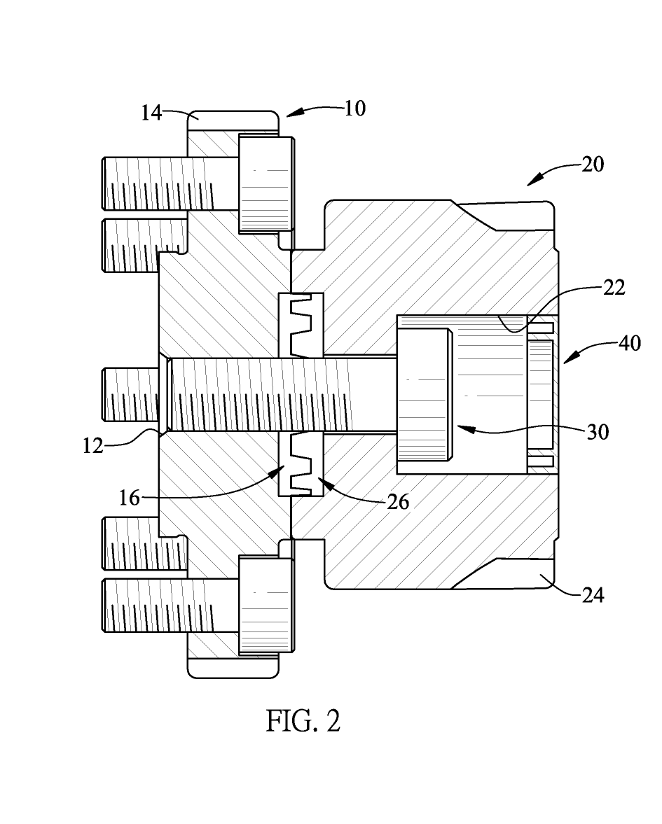

Referring to FIG. 2, the first curvic coupling member 16, which is formed on the coupling flange 10, is engaged with the second curvic coupling member 26, which is formed on the pinion 20. Then, the threaded bolt 30 is inserted in the screw hole 12 of the coupling flange 10 from the front end of the pinion 20 through the countersink hole 22. Thus, the pinion 20 and the coupling flange 10 are bonded. Furthermore, the coupling flange 10 can be serially connected a PTO axle of a gearbox (not shown).

The engagement of the first curvic coupling member 16 with the second curvic coupling member 26, power can be transferred between the coupling flange 10 and the pinion 20 and they are synchronously movable. The shapes and numbers of the first-type curvic teeth 162 and the second-type curvic teeth 262, straight concave teeth, straight convex teeth, concave-concave teeth, concave-convex teeth, convex-convex teeth or convex-concave teeth, an error is small and precision is high. In operation, the coupler provides positional rigidity no matter it is subjected to a radial force, and axial force or a tangential force. The concentricity of the elements and the precision of the positioning of the elements are automatically increased after wearing due to the configuration of the curvic teeth. Moreover, the insertion of the threaded bolt 30 from the front end of the pinion 20 renders it easy to loosen the threaded bolt 30 to remove the pinion 20 and replace it with a new one.

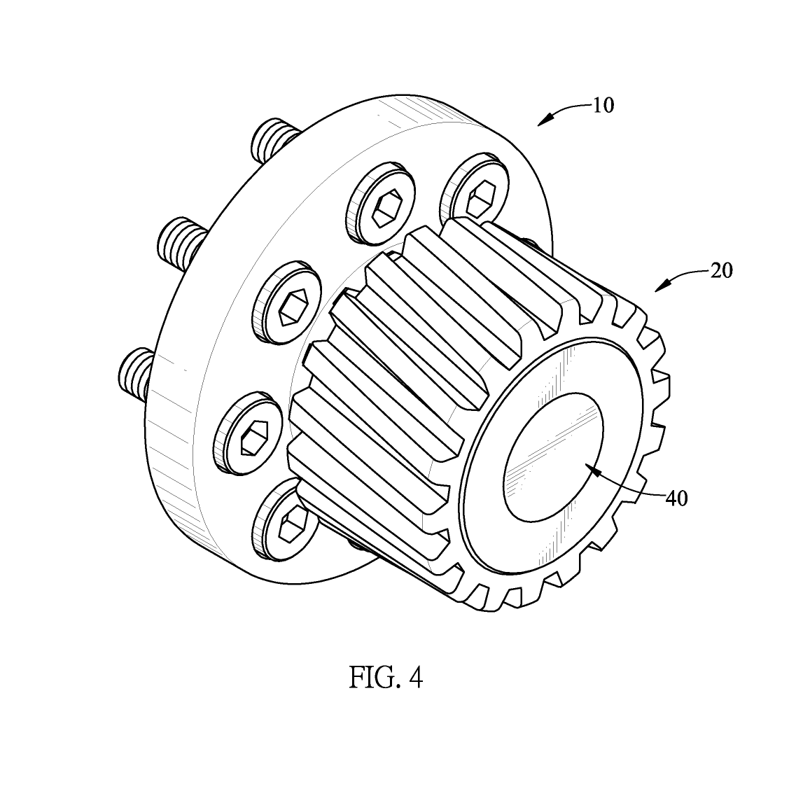

Referring to FIG. 4, there is a coupler according to a second embodiment of the present invention. The second embodiment is identical to the first embodiment except for that the coupling flange 10 does not include any teeth on the periphery thereof. That is, the teeth 14 of the first embodiment are omitted from the second embodiment.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A coupler for a take-out axle of a gearbox comprising:
a coupling flange (10) comprising a front end, a screw hole (12) made at the front end thereof, and a first curvic coupling member (16) formed at the front end thereof, wherein the screw hole (12) and the first curvic coupling member (16) are arranged in a concentric manner;
a pinion (20) connected to the front end of the coupling flange (10) and concentrically formed with a rear end, a second curvic coupling member (26) formed on the rear end thereof corresponding to the first curvic coupling member (16), and a countersink hole (22) made throughout the pinion (20); and
a threaded bolt (30) inserted in the screw hole (12) from the front end of the pinion (20) through the countersink hole (22) to bond the pinion (20) and the coupling flange (10) and to engage the first curvic coupling member (16) with the second curvic coupling member (26).

2. The coupler according to claim 1, wherein the pinion (20) further comprises teeth (24) formed on a periphery thereof.

3. The coupler according to claim 2, further comprising a cover (40) fitted in the countersink hole (22), flush with the front end of the pinion (20).

4. The coupler according to claim 1, wherein the coupling flange (10) further comprises teeth (14) formed on a periphery thereof.

5. The coupler according to claim 4, further comprising a cover (40) fitted in the countersink hole (22), flush with the front end of the pinion (20).

6. The coupler according to claim 1, further comprising a cover (40) fitted in the countersink hole (22), flush with the front end of the pinion (20).

7. The coupler according to claim 1, wherein the first curvic coupling member (16) comprises first-type curvic teeth (162) formed at an end thereof and separated from each other, wherein the first-type curvic teeth (162) are selected from the group consisting of straight concave teeth, straight convex teeth, concave-concave teeth, concave-convex teeth, convex-convex teeth or convex-concave teeth.

8. The coupler according to claim 7, wherein the pinion (20) further comprises teeth (24) formed on a periphery thereof.

9. The coupler according to claim 8, further comprising a cover (40) fitted in the countersink hole (22), flush with the front end of the pinion (20).

10. The coupler according to claim 7, wherein the coupling flange (10) further comprises teeth (14) formed on a periphery thereof.

11. The coupler according to claim 10, further comprising a cover (40) fitted in the countersink hole (22), flush with the front end of the pinion (20).

12. The coupler according to claim 7, further comprising a cover (40) fitted in the countersink hole (22), flush with the front end of the pinion (20).

13. The coupler according to claim 7, wherein the second curvic coupling member (26) comprises second-type curvic teeth (262) formed at an end thereof and separated from each other, wherein the second-type curvic teeth (262) are selected from the group consisting of straight concave teeth, straight convex teeth, concave-concave teeth, concave-convex teeth, convex-convex teeth or convex-concave teeth.

14. The coupler according to claim 13, wherein the pinion (20) further comprises teeth (24) formed on a periphery thereof.

15. The coupler according to claim 14, further comprising a cover (40) fitted in the countersink hole (22), flush with the front end of the pinion (20).

16. The coupler according to claim 13, wherein the coupling flange (10) further comprises teeth (14) formed on a periphery thereof.

17. The coupler according to claim 16, further comprising a cover (40) fitted in the countersink hole (22), flush with the front end of the pinion (20).

18. The coupler according to claim 17, further comprising a cover (40) fitted in the countersink hole (22), flush with the front end of the pinion (20).
